(19) United States
(12) Patent Application Publication
(10) Pub. No.: US 2026/0022202 A1
(43) Pub. Date: Jan. 22, 2026

(54) UV-CURABLE COMPOSITION AND USE THEREOF

(71) Applicants: DOW TORAY CO., LTD., Shinagawa-Ku, Tokyo (JP); DOW SILICONES CORPORATION, Midland, MI (US)

(72) Inventors: Takuya OGAWA, Ichihara-shi, Chiba (JP); Yungjin PARK, Chungcheongbuk-Do (KR)

(21) Appl. No.: 19/114,328

(22) PCT Filed: Sep. 26, 2023
(86) PCT No.: PCT/JP2023/034979

§ 371 Date: Mar. 21, 2025

(30) Foreign Application Priority Data
Sep. 27, 2022 (JP) 2022-153795

(51) Int. Cl. C08G 59/30; C08G 59/22; C08G 59/24; C08G 59/50; C08G 59/72; C09D 163/00

(52) U.S. Cl. CPC C08G 59/306; C08G 59/223; C08G 59/24; C08G 59/5073; C08G 59/72; C09D 163/00; C08G 2150/00

(57) ABSTRACT

Provided is an ultraviolet light curable composition containing a silicon atom, which provides a product obtained by curing that has excellent mechanical properties and low outgassing properties, and which also has excellent workability when applied to a substrate. The ultraviolet light curable composition includes: (A) one or more organopolysiloxanes or organosilanes having, on average, more than one cationically polymerizable functional group per molecule; (B) a compound that releases a basic substance when heated at 60 to 200° C.; and (C) a photoacid generating agent. The composition is substantially free of organic solvent, and the viscosity of the entire composition, measured at 25° C. using an E-type viscometer, is 500 mPa·s or less.

### TECHNICAL FIELD

The present invention relates to an ultraviolet light curable composition that can be cured by actinic rays, such as ultraviolet rays or electron beams, in particular to an ultraviolet light curable composition containing an organosilicon compound, and preferably an organosilane and/or an organopolysiloxane, and particularly relates to a ultraviolet light curable composition that provides a cured product having favorable low outgassing (volatile gas) properties, and excellent coatability. The curable composition of the present invention has low outgassing properties and excellent mechanical properties, and is suitable as an insulating material for electronic devices and electric devices, particularly display devices, and particularly as a material for use as a coating layer or protective layer. Furthermore, the composition has excellent application properties and superior wettability to substrates, thus being useful as an inkjet printing material.

### BACKGROUND ART

Due to high heat resistance and excellent chemical stability, silicone resins have been used as coating agents, potting agents, insulating materials, and the like for electronic and electrical devices. Silicone resins are reported to include ultraviolet light curable silicone compositions.

Touch panels are used in various display devices such as mobile devices, industrial equipment, car navigation systems, and the like. In order to improve detection sensitivity, electrical influence from light emitting sites such as light-emitting diodes (LED), organic EL devices (OLED), and the like must be suppressed, and an insulating layer is usually disposed between the light-emitting part and the touchscreen.

On the other hand, thin display devices such as OLEDs and the like have a structure in which a plurality of functional thin layers are stacked. In recent years, studies have been started in order to improve the overall reliability of display devices, particularly flexible display devices, by laminating an insulating layer with high flexibility onto the touchscreen layer. In addition, the inkjet printing method has been adopted as a processing method for organic layers to improve productivity. Therefore, a material that can be processed by the inkjet printing method is required for the aforementioned insulating layer.

International Patent Application Publication WO2019/117298 discloses a sealant for electronic devices that contains a disiloxane compound having an ultraviolet light curable functional group, a polysiloxane having an ultraviolet light curable functional group, and an optionally blended silicon-free compound having an ultraviolet light curable functional group, and that can be applied by an inkjet method. However, no chemical consideration is given to reducing the outgassing generated at high temperature, so it cannot be said that the amount of outgassing generated from the sealant is sufficiently low.

Meanwhile, International Patent Application Publication No. WO2006/100978 and Japanese Unexamined Patent Application No. 2004-231923 disclose actinic radiation curable compositions which contain alicyclic epoxy or oxetane compounds having a unique structure and which are ink-jet printable. Herein, the use of a thermal base generating agent is suggested and evaluated, but although there is a description that the thermal base generating agent is used as an additive for improving the discharge stability and storage stability of the composition (paragraph [0211] of WO 2006/100978), there is no description regarding outgassing of the cured product. Furthermore, these patents do not describe nor suggest curable compositions containing organopolysiloxanes or organosilanes containing epoxy groups or oxetanyl groups.

Outgassing properties at high temperature remains a property that needs to be improved in ultraviolet light curable sealants for electric and electronic devices, particularly in curable compositions containing organopolysiloxanes or organosilanes.

### RELATED ART DOCUMENTS

### Patent Documents

Patent Document 1: WO2019-117298

Patent Document 2: WO2006-100978

Patent Document 3: Japanese Unexamined Patent Application 2004-231923

### SUMMARY OF THE INVENTION

### Problem to Be Solved by the Invention

As described above, ultraviolet light curable organopolysiloxane compositions, particularly inkjet printable ultraviolet light curable organopolysiloxane compositions, have been widely disclosed, but there remains a need for an ultraviolet light curable composition that has low outgassing properties in the cured product, as well as excellent workability, particularly low viscosity, for application to a substrate. The present invention provides a curable composition, in particular an ultraviolet light curable composition containing a silicon atom, that can provide a product by curing that has low outgassing properties, and excellent workability when applied to a substrate.

### Means for Solving the Problem

The present invention was achieved based on a discovery that an ultraviolet light curable composition obtained by combining (A) one or more organopolysiloxanes or organosilanes having, on average, more than one cationically polymerizable functional group per molecule, (B) a compound that releases a basic substance when heated at 60 to 200° C., and (C) a photoacid generating agent has low viscosity and excellent workability when applied to a substrate, and a cured product obtained by curing the composition exhibits low outgassing properties.

The present invention relates to an ultraviolet light curable composition containing an organosilicon compound, particularly an ultraviolet light curable organopolysiloxane composition, and the composition is cured by an ultraviolet light curable functional group forming a bond. However, the curing method is not limited to ultraviolet light irradiation, and an arbitrary method in which a ultraviolet light curable functional group can cause a curing reaction can be used. For example, electron beam irradiation may be used to cure the composition of the present invention.

The ultraviolet light curable composition of the present invention includes (A) one

or more organopolysiloxanes or organosilanes having, on average, more than one cationically polymerizable functional group per molecule; (B) a compound that releases a basic substance when heated at 60 to 200° C.; and (C) a photoacid generating agent, wherein the viscosity of the entire composition measured at 25° C. using an E-type viscometer is 500 mPa·s or less, the composition is substantially free of organic solvent, and the cured product has low outgassing properties when the composition is cured. Note that unless otherwise specified herein, the viscosity of a substance is the value measured using an E-type viscometer at 25° C.

The cationically polymerizable reactive group contained in component (A) of the present invention is any group capable of forming a bond in the presence of an acid generated by the photoacid generating agent component (C) upon irradiation with ultraviolet light or the like. Examples of cationically polymerizable functional groups include vinyl ether groups, epoxy group-containing groups, oxetane group-containing groups, and other groups, such as CH₂═CH—O—(CH₂)ₙ— (where n is an integer from 3 to 20), glycidyloxy —(CH₂)ₙ— (where n is an integer from 3 to 20), 3,4-epoxycyclohexyl —(CH₂)ₙ— (where n is an integer from 2 to 20), and the like. The cationically polymerizable functional group is preferably an epoxy group-containing group. Examples of particularly preferable groups include glycidyloxypropyl groups, epoxycyclohexylalkyl groups, and particularly a 3,4-epoxycyclohexylethyl group. The organopolysiloxane or organosilane of component (A) described above may be a linear, branched, or cyclic organopolysiloxane or organosilane, and has an average of more than one cationically polymerizable functional group (R) per molecule. The cationically polymerizable reactive group will be described below in relation to the following formula (1), but the following description applies to all of the cationic reactive groups contained in component (A) of the present invention.

Component (A) is preferably a linear, branched, or cyclic organopolysiloxane or organosilane expressed by the average compositional formula:

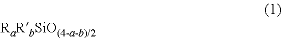

(In the formula, R is a cationically polymerizable functional group, R′ represents a group selected from monovalent hydrocarbon groups, hydroxyl groups, and alkoxy groups excluding the cationically polymerizable functional group; a and b are numbers that satisfy the following conditions: 1≤a+b<4 and 0.01≤a/(a+b)≤0.5, and on average, more than one R is present in each molecule).

Component (A) preferably includes: (A1) one or more organopolysiloxane having on average two or more cationically polymerizable functional groups per molecule; and (A2) one or more organosilanes or organopolysiloxanes having one or more cationically polymerizable functional group per molecule. Component (A2) must contain at least one of an organosilane or an organopolysiloxane, so the scope of the present invention is to contain both an organosilane and an organopolysiloxane as component (A2).

Component (A1) is preferably at least one type of organopolysiloxane having a cationically polymerizable functional group, selected from a group consisting of: organopolysiloxanes expressed by the following formula (2):

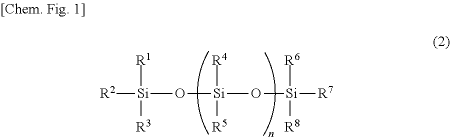

(where two or more, on average, of all R¹ to R⁸ groups per molecule are cationically polymerizable functional groups; other R¹ to R⁸ groups independently represent an unsubstituted or fluorine-substituted monovalent hydrocarbon group; and n is a number of 0 or more and 20 or less);
organopolysiloxanes expressed by the average unit formula (3):

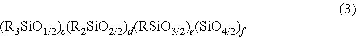

(where R independently represents a group selected from cationically polymerizable functional groups and unsubstituted or fluorine-substituted monovalent hydrocarbon groups, at least two of all Rs are cationically polymerizable functional groups, (e+f) is a positive number, c is 0 or a positive number, and d is a number within a range of 0 to 10); cyclic organpolysiloxanes expressed by the following formula (4):

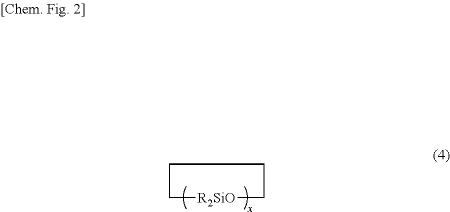

(where R independently represents a group selected from cationically polymerizable functional groups and unsubstituted or fluorine-substituted monovalent hydrocarbon groups, x is an integer of 3 to 10, and at least two cationically polymerizable functional groups are present in each molecule); and
mixtures of two or more organopolysiloxane arbitrarily selected therefrom.

The number of cationically polymerizable functional groups in component (A1) is preferably two on average per molecule.

Component (A1) may be a linear organopolysiloxane having cationically polymerizable functional groups only on both ends of a molecular chain, and having, on average, 2 to 12 silicon atoms.

Component (A2) is preferably an organosilicon compound containing in each molecule one cationically polymerizable functional group selected from a group consisting of:

organopolysiloxanes expressed by the following formula (2′):

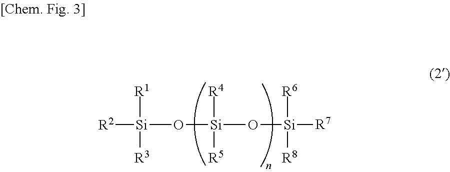

(where of all R¹ to R⁸ groups in the formula, only one cationically polymerizable functional group is present in each molecule; the other R¹ to R⁸ are independently an unsubstituted or fluorine-substituted monovalent hydrocarbon group; and n is a number for which the viscosity of a polyorganosiloxane expressed by formula (2′) is 1 to 20 mPa-s at 25° C., and n may be 0);
cyclic organopolysiloxanes expressed by the following formula (4′):

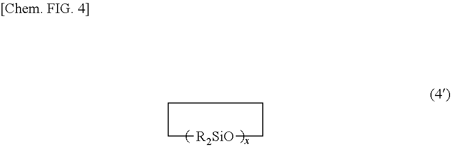

(where R is independently a group selected from cationically polymerizable functional groups and unsubstituted or fluorine-substituted monovalent hydrocarbon groups, x is an integer of 3 to 10, and only one cationically polymerizable functional group is provided in each molecule); and
organosilanes expressed by the following formula (5):

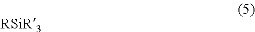

(where R is a cationically polymerizable functional group, and R′ is a group selected from monovalent hydrocarbons, hydroxyl groups, and alkoxy groups excluding the cationically polymerizable functional group).

The aforementioned component (A2) is preferably an organopolysiloxane having three or more silicon atoms and having one cationically polymerizable functional group in each molecule.

The ratio of component (A1) to component (A2) in the ultraviolet light curable composition is preferably 10/90 to 90/10 (A1/A2; mass ratio).

Component (B) is preferably a compound that releases a basic substance when heated at 60 to 120° C.

Component (B) may be a compound containing a nitrogen-containing cyclic base.

The viscosity of the entire composition, as measured at 25° C. using an E-type viscometer, is preferably 5 to 30 mPa·s.

The present invention further provides an insulative coating agent containing the aforementioned ultraviolet light curable composition. The ultraviolet light curable composition of the present invention is useful as an insulative coating agent.

The present invention further provides a cured product of the aforementioned ultraviolet light curable composition. Furthermore, the present invention also provides a method of using the cured product as an insulative coating layer.

The present invention further provides a display device such as a liquid crystal display, organic EL display, or organic EL flexible display that includes a layer containing a cured product of the aforementioned ultraviolet light curable composition.

### DESCRIPTION OF THE PREFERRED EMBODIMENTS

A configuration of the present invention will be further described in detail below.

The ultraviolet light curable composition of the present invention contains, as essential components: (A) one or more organopolysiloxanes having, on average, more than one cationically polymerizable functional group per molecule; (B) a compound that releases a basic substance upon heating at 60 to 200° C.; and (C) a photoacid generating agent, and may further contain a component selected from various additives, as necessary. However, the curable composition of the present invention is characterized by being substantially free of an organic solvent.

In the present specification, the term “organosilicon compound” is used as a term to refer to a concept that includes organosilanes, organosiloxane oligomers, and organopolysiloxanes.

In the present specification, the term “polysiloxane” refers to a siloxane unit (Si—O) with a degree of polymerization of two or more, in other words with an average of two or more Si—O bonds per molecule. Polysiloxanes include siloxane oligomers such as disiloxanes, trisiloxanes, tetrasiloxanes, and the like, as well as siloxane polymers with higher degrees of polymerization.

### Component (A)

Component (A) is one or more organopolysiloxanes or organosilanes having, on average, more than one cationically polymerizable functional group per molecule. The molecular structure thereof can be arbitrary so long as the object can be achieved. The cationically polymerizable functional group contained in component (A) is preferably an epoxy group-containing group. In the present invention, the one or more organopolysiloxane or organosilane also includes combinations of organopolysiloxanes and organosilanes.

In one embodiment of the present invention, component (A) is preferably a linear, branched, or cyclic organopolysiloxane or organosilane, particularly preferably a linear organopolysiloxane or organosilane, expressed by the following average compositional formula:

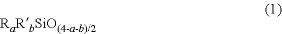

or a mixture thereof.

In formula (1),
R is a cationically polymerizable functional group;
R′ is a group selected from monovalent hydrocarbon groups, hydroxyl groups, and alkoxy groups, excluding the cationically polymerizable functional group; and
a and b are numbers that satisfy the following conditions: 1≤a+b≤4 and 0.01≤a/(a+b)≤0.5, and preferably 2≤a+b≤3 and 0.05≤a/(a+b)≤0.34.

The cationically polymerizable functional group represented by R in formula (1) is generally an organic group that can generate a bond between groups through the formation of a cationic intermediate upon irradiation with ultraviolet light in the presence or absence of a photoinitiator. In the present invention, this includes any group capable of forming a bond in the presence of an acid generated by the photoacid generating agent, component (C), upon irradiation with ultraviolet light or the like. Examples of cationically polymerizable functional groups include vinyl ether groups, epoxy group-containing groups, oxetane group-containing groups, and other groups, such as CH₂═CH—O—(CH₂)ₙ— (where n is an integer from 3 to 20), glycidyloxy —(CH₂)ₙ— (where n is an integer from 3 to 20), 3,4-epoxycyclohexyl —(CH₂)ₙ— (where n is an integer from 2 to 20), and the like.

The cationically polymerizable functional group is preferably an epoxy group-containing group. Examples of particularly preferable groups include glycidyloxypropyl groups, epoxycyclohexylalkyl groups, and particularly a 3,4-epoxycyclohexylethyl group. The linear, branched, or cyclic organopolysiloxane or organosilane expressed by the above average compositional formula has, on average, more than one cationically polymerizable functional group (R) per molecule.

R′ represents a monovalent hydrocarbon group, which includes unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group. R′ is not inherently a cationically polymerizable functional group.

Component (A) expressed by formula (1) above has a viscosity at 25° C. of 1 to 1000 mPa·s, 5 to 500 mPa·s, or 10 to 100 mPa·s, and most preferably 10 to 50 mPa·s. The viscosity of the organopolysiloxane or organosilane can be adjusted by varying the ratio of a and b in formula (1), as well as the molecular weight.

Component (A) preferably has an average of 1.1 to 20, more preferably 1.2 to 12, and particularly preferably 1.3 to 12 silicon atoms per molecule.

In one preferred embodiment, component (A) includes: (A1) one or more organopolysiloxane having on average two or more cationically polymerizable functional groups per molecule; and (A2) one or more organosilanes or organopolysiloxanes having one or more cationically polymerizable functional group per molecule. In the present invention, the one or more organosilanes or organopolysiloxanes includes the use of combinations of organosilanes and organopolysiloxanes. Thereby, the crosslink density of the resulting organopolysiloxane cured product can be controlled, and the ability to adjust various physical properties can be enhanced. Specifically, component (A2) enhances the flexibility of the cured product obtained from the composition, and is effective in designing organopolysiloxanes having high tensile elongation.

Component (A1) can be an organopolysiloxane expressed by formula (2) below

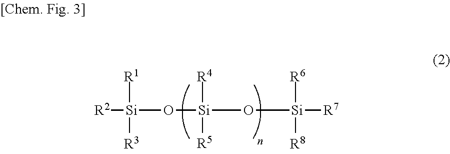

(in the formula, of all R¹ to R⁸ groups, on average two or more are cationically polymerizable functional groups in each molecule; the remaining R¹ to R⁸ are each independently an unsubstituted or fluorine-substituted monovalent hydrocarbon group; and n is a number of 0 or more and 20 or less).

In formula (2′), of all R¹ to R⁸ groups, an average of two or more are ultraviolet light curable functional groups in each molecule. The cationically polymerizable functional group can be the functional group described by the above formula (1). Furthermore, R¹ to R⁸ other than the cationically polymerizable functional groups are each independently a group selected from unsubstituted or fluorine-substituted monovalent hydrocarbon groups, preferably unsubstituted or fluorine-substituted alkyl, cycloalkyl, arylalkyl, or aryl groups having 1 to 20 carbon atoms, and similarly, the functional groups described in formula (1) can be used.

The number of cationically polymerizable functional groups provided by the organopolysiloxane of formula (2′), serving as component (A1) is, as a whole, 2 to 6 on average per molecule, preferably 2 to 5, more preferably 2 to 4, particularly preferably 2 to 3, and most preferably 2.

In particular, one of R¹ to R³ in formula (2′) and one of R⁶ to R⁸ are preferably cationically polymerizable functional groups. Furthermore, only one of R¹ to R³ in formula (2′) and only one of R⁶ to R⁸ are particularly preferably cationically polymerizable functional groups.

For n in formula (2′), the viscosity of the organopolysiloxane expressed by formula (2′) at 25° C. is preferably 1 to 1000 mPa·s, more preferably 5 to 500 mPa·s, particularly preferably 10 to 100 mPa·s, and most preferably 10 to 50 mPa·s. A person with ordinary skill in the art can easily determine the value of n without excess trial and error such that the viscosity of the organopolysiloxane of formula (2) is within the aforementioned viscosity range. In general, however, the number of silicon atoms per molecule is preferably 2 to 12, and particularly preferably 2 to 10, in order for the compound of formula (2′) to have the desired viscosity.

The organopolysiloxane of formula (2) can be used as one type or as a mixture of two or more types. If two or more organopolysiloxanes are used as a mixture, the viscosity of the mixture at 25° C. is preferably the viscosity described above.

Furthermore, the compound of component (A1) may be an organopolysiloxane expressed by the following average unit formula (3).

Average unit formula (3):

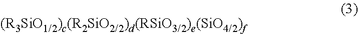

In formula (3), each R is independently a group selected from cationically polymerizable functional groups and unsubstituted or fluorine-substituted monovalent hydrocarbon groups, at least two of all Rs are cationically polymerizable functional groups, (e+f) is a positive number, a is 0 or a positive number, and b is a number in a range of 0 to 10. The cationically polymerizable functional groups and monovalent hydrocarbon groups are as defined above for formula (1). Furthermore, a preferred viscosity of the organopolysiloxane expressed by formula (3) is as specified above for the organopolysiloxane expressed by formula (1).

The number of ultraviolet light curable functional groups provided by the organopolysiloxane expressed by formula (3) is preferably 2 to 5, more preferably 2 to 4, particularly preferably 2 to 3, and most preferably 2, per molecule.

The organopolysiloxane expressed by formula (3) preferably has 3 to 20 silicon atoms per molecule, more preferably 3 to 12 atoms, and particularly preferably 5 to 12 atoms.

Specific examples of the organopolysiloxane expressed by the aforementioned formula (A1), and particularly the formula (2) or (3), include: 1,3-[2-(3,4-epoxycyclohexyl)ethyl]-1,1,3,3-tetramethyldisiloxane; 1,5-bis[2-(3,4-epoxycyclohexyl)ethyl]-1,1,3,3,5,5-hexamethyltrisiloxane; 1,7-bis[2-(3,4-epoxycyclohexyl)ethyl]-1,1,3,3,5,5,7,7-1,9-bis[2-(3,4-epoxycyclohexyl)ethyl]-1,1,3,3,5,5,7,7,9,9-octamethyltetrasiloxane; decamethylpentasiloxane; methyl(tris[2-(3,4-epoxycyclohexyl)ethyl]dimethylsiloxy)silane; tetrakis([2-(3,4-epoxycyclohexyl)ethyl]dimethylsiloxy)silane; 1,3-(3-glycidoxypropyl)-1,1,3,3-tetramethyldisiloxane; 1,5-bis(3-glycidoxypropyl)-1,1,3,3,5,5-hexamethyltrisiloxane; 1,7-bis(3-glycidoxypropyl)-1,1,3,3,5,5,7,7-octamethyltetrasiloxane; 1,9-bis(3-glycidoxypropyl)-1,1,3,3,5,5,7,7,9,9-decamethylpentasiloxane; polydimethylsiloxane capped on both terminals with (3,4-epoxycyclohexylethyldimethylsilyl); polydimethylsiloxane capped on both terminals with (3-glycidoxypropyldimethylsilyl); dimethylsiloxy/(methyl-3,4-epoxycyclohexylethylsiloxy) copolymers capped on both terminals with trimethylsilyl; dimethylsiloxy/(methyl-3-glycidoxypropylsiloxy) copolymers capped on both terminals with trimethylsilyl; dimethylsiloxy/(methyl-3,4-epoxycyclohexylethylsiloxy) copolymers capped on both terminals with (3,4-epoxycyclohexylethyldimethylsilyl); and dimethylsiloxy/(methyl-3-glycidoxypropylsiloxy) copolymers capped on both terminals with (3-glycidoxypropyldimethylsilyl).

Furthermore, the compound of component (A1) may be a cyclic organopolysiloxane expressed by the following formula (4):

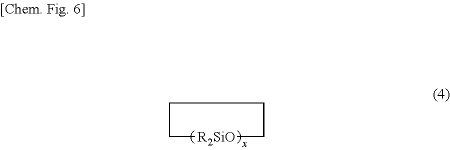

(where R each independently represents a group selected from cationically polymerizable functional groups and unsubstituted or fluorine-substituted monovalent hydrocarbon groups, x is an integer of 3 to 10, and at least two cationically polymerizable functional groups are present in each molecule).

The cationically polymerizable functional group and the unsubstituted or fluorine-substituted monovalent hydrocarbon group, which can be represented by R in formula (4), are as defined for formula (1) above.

Furthermore, the preferred viscosity of the organopolysiloxane expressed by formula (4) is also as defined above for the organosilicon compound expressed by formula (1).

Specific examples of the cyclic organopolysiloxane expressed by formula (4) include 1,3,5-trimethyl-1,3,5-tri[2-(3,4-epoxycyclohexyl)ethyl]cyclotrisiloxane, 1,3,5-trimethyl-1,3,5-tri(3-glycidoxypropyl)cyclotrisiloxane, 1,3,5,7-tetramethyl-1,3,5,7-tetra[2-(3,4-epoxycyclohexyl]ethyl]cyclotrisiloxane, 1,3,5,7-tetramethyl-1,3,5,7-tetra(3-glycidoxypropyl)cyclotetrasiloxane, 1,3,5,7,9-pentamethyl-1,3,5,7,9-penta[2-(3,4-epoxycyclohexyl)ethyl]cyclopentasiloxane, and 1,3,5,7,9-pentamethyl-1,3,5,7,9-penta(3-glycidoxypropyl)cyclopentasiloxane.

The organopolysiloxanes expressed by formulas (2) to (4) can each be one type, or optionally a combination of two or more types as component (A1).

Component (A1) is particularly preferably one or more organopolysiloxane selected from the group consisting of the aforementioned linear organopolysiloxanes expressed by formula (2), cyclic organopolysiloxanes expressed by formula (4), and combinations thereof.

Component (A1) is a linear organopolysiloxane having cationically polymerizable functional groups only at both ends of each molecular chain and an average number of silicon atoms in the range of 2 to 12, and particularly preferably a linear dimethylpolysiloxane having epoxy group-containing groups at both ends of each molecular chain.

A compound recommended as component (A1) is one compound selected from the group consisting of 1,3-[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,9-bis[2-(3,4-epoxycyclohexyl)ethyl]-1,1,3,3,5,5,7,7,9,9-decamethylpentasiloxane, methyl(tris[2-(3,4-tetrakis([2-(3,4-epoxycyclohexyl)ethyl]dimethylsiloxy)silane, epoxycyclohexyl)ethyl]dimethylsiloxy)silane, polydimethylsiloxane capped on both terminals with (3,4-epoxycyclohexylethyldimethylsilyl), or a combination of two or more of these compounds. Of these, 1,3-[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, and 1,9-bis[2-(3,4-epoxycyclohexyl)ethyl]-1,1,3,3,5,5,7,7,9,9-decamethylpentasiloxane are particularly preferred.

The aforementioned component (A2) is an organosilicon compound having one cationically polymerizable functional group per molecule on an organosilane or organopolysiloxane backbone. Component (A2) primarily has an effect of controlling the crosslinking density of a cured product obtained from the composition of the present invention, and the physical properties of the cured product is adjusted, while simultaneously reducing the viscosity of the composition.

Component (A2) is preferably an organosilicon compound containing in each molecule one cationically polymerizable functional group selected from a group consisting of:

organo(poly)siloxanes expressed by the following formula (2′):

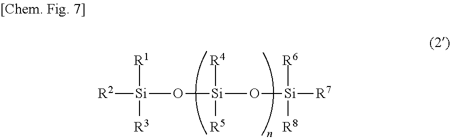

(where of all R¹ to R⁸ groups in the formula, only one cationically polymerizable functional group is present in each molecule; the other R¹ to R⁸ are independently an unsubstituted or fluorine-substituted monovalent hydrocarbon group; and n is a number for which the viscosity of a polyorganosiloxane expressed by formula (2′) is 1 to 20 mPa-s at 25° C., and n may be 0);
cyclic organopolysiloxanes expressed by the following formula (4′):

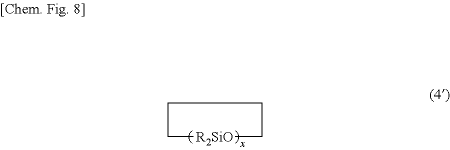

(where R is independently a group selected from cationically polymerizable functional groups and unsubstituted or fluorine-substituted monovalent hydrocarbon groups, x is an integer of 3 to 10, and only one cationically polymerizable functional group is provided in each molecule); and
organosilanes expressed by the following formula (5):

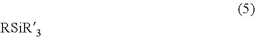

(where R is a cationically polymerizable functional group, and R′ is a group selected from monovalent hydrocarbons, hydroxyl groups, and alkoxy groups excluding the cationically polymerizable functional group).

Of the R¹ to R⁸ groups in the organopolysiloxane expressed by formula (2′), one cationically polymerizable functional group is included in each molecule. The cationically polymerizable functional group can be the functional group described by the above formula (1). Furthermore, R¹ to R⁸ other than the cationically polymerizable functional groups are each independently a group selected from unsubstituted or fluorine-substituted monovalent hydrocarbon groups, preferably unsubstituted or fluorine-substituted alkyl, cycloalkyl, arylalkyl, or aryl groups having 1 to 20 carbon atoms, and similarly, the functional groups described in formula (1) can be used.

The position of the cationically polymerizable functional group in the organopolysiloxane expressed by formula (2′) is not particularly limited, and the group may be a terminal substituent of the molecular chain, for example, one of R¹ to R³ groups, or may be a side chain substituent, or in other words, the R⁴ or R⁵ group.

The organosilicon compound expressed by the above formula (2′) preferably has a viscosity at 25° C. of 1 to 20 mPa·s, and more preferably 2 to 10 mPa·s. The viscosity of the organosilicon compound can be adjusted by changing the value of n in formula (2′), which is a number equal to or greater than 0.

The organosilicon compound expressed by formula (2′) is preferably a compound having 1 to 10, and preferably 2 to 4 silicon atoms per molecule.

Of the R groups in the cyclic organopolysiloxane expressed by formula (4′), one cationically polymerizable functional group is included in each molecule. The cationically polymerizable functional group and other groups can be the functional groups described for the above formula (1).

Furthermore, the preferred viscosity of the cyclic organopolysiloxane expressed by formula (4′) is also as defined above for the organosilicon compound expressed by formula (1).

The cationically polymerizable functional group R of the organosilane expressed by formula (5) is as defined for the organosilicon compound expressed by formula (1) above. The other R′ groups can be a group selected from monovalent hydrocarbon groups, hydroxyl groups, and alkoxy groups excluding cationically polymerizable functional groups, and the functional groups described for the above formula (1) can be used.

The organopolysiloxanes or organosilanes expressed by the above formulas (2′), (4′), and (5) can be used alone or in any combination of two or more as component (A2). Component (A2) is particularly preferably one or more organopolysiloxane selected from the group consisting of the aforementioned linear organopolysiloxanes expressed by formula (2′), cyclic organopolysiloxanes expressed by formula (4′), and combinations thereof.

Component (A2) is particularly preferably a linear organopolysiloxane having one cationically polymerizable functional group and having an average of 2 to 5 silicon atoms, particularly preferably 3 to 5 silicon atoms, and is particularly preferably a linear polysiloxane in which all of the substituents other than the cationically polymerizable functional group are methyl groups.

Specific examples of the component (A2) organopolysiloxane having one cationically polymerizable functional group in each molecule include 1-[2-(3,4-epoxycyclohexyl)ethyl]-1,1,3,3,3-pentamethyldisiloxane, 1-[2-(3,4-epoxycyclohexyl)ethyl]-1,1,3,3,5,5,5-heptamethyltrisiloxane, 3-[2-(3,4-epoxycyclohexyl)ethyl]-1, 1, 1,3,5,5,5-heptamethyltrisiloxane, 1-[2-(3,4-epoxycyclohexyl)ethyl]-1,1,3,3,5,5,7,7,7-nonamethyltetrasiloxane, 1-(3-glycidoxypropyl)-1,1,3,3,3-pentamethyldisiloxane, 1-(3-glycidoxypropyl)-1,1,3,3,5,5,5-heptamethyltrisiloxane, 3-(3-glycidoxypropyl)-1,1,1,3,5,5,5-heptamethyltrisiloxane, and 1-(3-glycidoxypropyl)-1,1,3,3,5,5,7,7,7-nonamethyltetrasiloxane, 1-[2-(3,4-epoxycyclohexyl)ethyl]-1,3,3,5,5,7,7-heptamethylcyclotetrasiloxane, and 1-(3-glycidoxypropyl)-1,3,3,5,5,7,7-heptamethylcyclotetrasiloxane.

Components (A1) and (A2) can be used at an arbitrary mass ratio, but the ratio of component (A1) is 10 mass % or more and 90 mass % or less, preferably 30% or more and 80 mass % or less, and even more preferably 40 mass % or more and 70% or less, with respect to the total amount of components (A1) and (A2) being 100 mass %. In other words, the ratio of component (A2) is 10 mass % or more and 90 mass % or less, preferably 20 mass % or more and 70 mass % or less, and even more preferably 30 mass % or more and 60 mass % or less. When the viscosity is within this range, the viscosity of the curable composition can be adjusted appropriately, and the properties desired for a material as an insulating coating layer, such as the mechanical properties and dielectric properties of the resulting cured product, can easily be adjusted.

### Component (B)

Component (B) is a compound that releases a basic substance when heated at 60 to 200° C., and is a component that improves the outgassing properties of the cured product obtained from the ultraviolet ray curable composition of the present invention, or in other words, contributes to reducing outgassing.

Component (B) in the present invention suppresses unintentional reactions in the ultraviolet light curable composition of the present invention in the presence of an acidic compound generated from the photoacid generating agent of component (C) as a curing catalyst, at a high temperature, for example, 60 to 200° C., particularly 80 to 150° C., and thereby can provide the effect of reducing the amount of outgassing generated. More specifically, component (B) is preferably a compound that releases basic substance molecules equivalent to 10 mol % or more of the amount used when heated for 30 minutes within the aforementioned temperature range, and the specific compounds described below can be used. The amount of released basic substance molecules can be determined by known measurement methods such as acid-base titration.

Component (B) can be a compound having various structures that are known to dissociate and/or decompose in a prescribed temperature range to release a basic substance. In the present invention, the structure of the compound is not particularly limited as long as the compound is capable of releasing a basic substance at high temperatures, specifically, at 60 to 200° C., and any compound selected from such a group of compounds can be used. Examples of component (B) include compounds commercially available as thermal base generating agents, preferably organic acid salts of 1,8-diazabicyclo[5.4.0]undeca-7-ene (DBU) and/or 1,5-diazabicyclo[4.3.0]non-5-ene (DBN), known as U-CAT SA (registered trademark) and U-CAT (registered trademark) series, and preferably have an active temperature in the range of 60° C. to 200° C.

Specific examples of compounds that can be used as component (B) include, for example, N-(2-nitrobenzyloxycarbonyl)imidazole, N-(3-nitrobenzyloxycarbonyl)imidazole, N-(4-nitrobenzyloxycarbonyl)imidazole, N-(5-methyl-2-nitrobenzyloxycarbonyl)imidazole, N-(4-chloro-2-nitrobenzyloxycarbonyl)imidazole, 1-(p-methoxycinnamoyl)imidazole, 1-(o-nitro-p-methoxycinnamoyl)imidazole, and other imidazole derivatives; 1-methyl-1-(4-biphenylyl)ethyl carbamate, 2-cyano-1,1-dimethylethyl carbamate, and other carbamates; urea, N,N-dimethyl-N′-methyl urea, 1,1′-(4-methyl-1,3-phenylene)bis(3,3-dimethylurea), and other ureas; guanidine trichloroacetate, guanidine phenylsulfonylacetate, guanidine phenylpropiolate, and other guanidines; 1,4-dihydronicotinamide, and other dihydropyridines; N-(isopropoxycarbonyl)-2,6-dimethylpiperidine, N-(tert-butoxycarbonyl)-2,6-dimethylpiperidine, N-(benzyloxycarbonyl)-2,6-dimethylpiperidine, and other dimethylpiperidines; tetramethylammonium phenylsulfonylacetate, tetramethylammonium phenylpropiolate, and other quaternary ammonium salts; 2-benzyl-2-dimethylamino-1-(4-morpholinophenyl)-butan-1-one, and other aminoketones; organic acid salts of cyclic amidine compounds, for example, DBU salts of organic acids such as phenol salt of 1,8-diazabicyclo[5.4.0]undec-7-ene (DBU) and ethyl hexanoate of 1,8-diazabicyclo[5.4.0]undec-7-ene; DBN salts of organic acids such as ethyl hexanoate of 1,5-diazabicyclo[4.3.0]non-5-ene (DBN); benzyltriphenylphosphonium bromide and other salts of triphenylphosphine derivatives; dicyandiamide, and the like. Note that in the present invention, the “organic acid” of component (B) refers to any organic compound having an acidic group, and the structure of the acidic group is not particularly limited, but a carboxyl group or a phenolic hydroxyl group is particularly preferred.

Furthermore, in consideration of the miscibility with component (A), storage stability, and basicity, component (B) is preferably a compound containing a nitrogen-containing cyclic base. Specifically, preferred compounds include the aforementioned imidazole derivatives, piperidine derivatives, and organic acid salts of cyclic amidine compounds, such as DBU salts of organic acids and DBN salts of organic acids. Among these, DBU salts of organic acids and

DBN salts of organic acids are particularly preferably used. In this case, the organic acid is preferably an organic acid selected from a group consisting of organic carboxylic acids, in particular alkyl carboxylic acids, especially C₁ to C₂₀ alkyl carboxylic acids, in particular C₆ to C₁₈ alkyl carboxylic acids, aromatic carboxylic acids such as phthalic acid, aromatic sulfonic acids such as p-toluenesulfonic acid, and aromatic compounds having a phenolic hydroxyl group, such as phenols or phenol novolac resins, in particular unsubstituted or alkyl-substituted phenols, and combinations of trimellitic acid and phenolic resins.

Component (B) is preferably a compound group that releases a basic substance when heated in a temperature range of 60 to 120° C., and more preferably a compound group where the temperature range is 80 to 120° C.

The preferred amount of component (B) used in the present invention is 0.01 to 5 mass % based on 100 mass % of the ultraviolet light curable composition. If the amount is less than the lower limit, the outgassing suppression effect is hardly observed, whereas if the amount used is more than the upper limit of the above conditions, the ultraviolet light curing properties of the composition will be adversely affected. The amount of component (B) is more preferably in a range of 0.1 to 1 mass % relative to 100 mass % of the curable composition.

On the other hand, the preferred amount of component (B) used in the ultraviolet light curable composition depends on the structure and molecular weight of the photoacid generating agent, component (C), which will be described below. As described above, in order to suppress an effect on the ultraviolet light curing properties of the present composition, the stoichiometric amount of component (B) is preferably equal to or less than the stoichiometric amount of component (C), and is preferably equal to or less than 80 mol %, more preferably equal to or less than 60 mol %, and even more preferably equal to or less than 50 mol %, of the stoichiometric amount of component (C).

### Component (C)

In addition to the above-mentioned components (A) and (B), the ultraviolet light-curable composition of the present invention contains component (C): a photoacid generating agent. Component (C) is a well-known type of photocationic polymerization initiator that generates a Bronsted acid or a Lewis acid upon irradiation with ultraviolet light, and this acid induces a reaction between cationically polymerizable functional groups.

The photoacid generating agent used in the curable composition of the present invention can be arbitrarily selected from those known in the art and is not particularly limited to a specific type. Strong acid-generating compounds, such as diazonium salts, sulfonium salts, iodonium salts, phosphonium salts, and the like, are known photoacid generating agents, and one or more type selected from these can be used. Examples of the photoacid generating agent include, but are not limited to, bis(4-tert-butylphenyl)iodonium hexafluorophosphate, cyclopropyldiphenylsulfonium tetrafluoroborate, dimethylphenacylsulfonium tetrafluoroborate, diphenyliodonium hexafluorophosphate, diphenyliodonium hexafluoroarsenate, diphenyliodonium tetrafluoromethanesulfonate, 2-(3,4-dimethoxystyryl)-4,6-bis (trichloromethyl)-1,3,5-triazine, 2-[2-(furan-2-yl)vinyl]-4,6-bis(trichloromethyl)-1,3,5-triazine, 4-isopropyl-4′-methyldiphenyliodonium tetrakis(pentafluorophenyl)borate, 2-[2-(5-methylfuran-2-yl) vinyl]-4,6-bis(trichloromethyl)-1,3,5-triazine, 2-(4-methoxyphenyl)-4,6-bis(trichloromethyl)-1,3,5-triazine, 2-(4-methoxystylyl)-4,6-bis (trichloromethyl)-1,3,5-triazine, 4-nitrobenzenediazonium tetrafluoroborate, triphenylsulfonium tetrafluoroborate, triphenylsulfonium bromide, tri-p-tolylsulfonium hexafluorophosphate, tri-p-tolylsulfonium trifluoromethanesulfonate, diphenyliodonium triflate, triphenylsulfonium triflate, diphenyliodonium nitrate, bis(4-tert-butylphenyl)iodonium perfluoro-1-butane sulfonate, bis(4-tert-butylphenyl)iodonium triflate, triphenylsulfonium perfluoro-1-butanesulfonate, N-hydroxynaphthalimide triflate, p-toluene sulfonate, diphenyliodonium p-toluenesulfonate, (4-tert-butylphenyl)diphenylsulfonium triflate, tris(4-tert-butylphenyl)sulfonium triflate, N-hydroxy-5-norbornene-2,3-dicarboxymide perfluoro-1-butanesulfonate, (4-phenylthiophenyl) diphenylsulfonium triflate, 4-(phenylthio)phenyldiphenylsulfonium triethyltrifluorophosphate, and the like. In addition to the aforementioned compounds, examples of photocationic polymerization initiators can include Omnicat 250, Omnicat 270 (produced by IGM Resins B.V.), CPI-310B, IK-1 (produced by San-Apro Ltd.), DTS-200 (produced by Midori Kagaku Co., Ltd.), and Irgacure 290 (produced by BASF), and other commercially available photoinitiators.

The amount of the photoacid generating agent added to the curable composition of the present invention is not particularly limited as long as the desired photocuring reaction occurs. In general, however, the amount of photoacid generating agent used is 0.1 to 10 mass %, preferably 0.2 to 5 mass %, and particularly preferably 0.5 to 4 mass %, relative to 100 mass % of the composition of the present invention.

In the present invention, in addition to the aforementioned photoacid generating agent, a photosensitizing agent as described below can also be used as a polymerization initiator. Use of a sensitizing agent can increase the photon efficiency of photopolymerization and the curing reaction, and is particularly effective when the coating thickness of the composition is relatively thick or when a relatively long-wavelength LED light source is used, because use of longer wavelength light for the polymerization reaction compared to only using a photoacid generating agent is feasible. While not limited thereto, examples of known photosensitizing agents include anthracene-based compounds, phenothiazine-based compounds, perylene-based compounds, cyanine-based compounds, melocyanine-based compounds, coumarin-based compounds, benzylidene ketone-based compounds, and (thio)xanthene- or (thio)xanthone-based compounds such as isopropylthioxanthone, 2,4-diethylthioxanthone, alkyl-substituted anthracenes, squarylium-based compounds, (thia)pyrylium-based compounds, porphyrin-based compounds, and the like, and any photosensitizing agent can be used in the curable composition of the present invention.

### Overall Viscosity of the Composition

The curable composition of the present invention can be used as a coating agent, and the viscosity of the entire composition is 500 mPa·s or less at 25° C., as measured using an E-type viscometer, in order for the composition to have suitable flowability and workability for application to the substrate. A preferred viscosity range is 5 to 80 mPa·s, even more preferably 5 to 50 mPa·s, and particularly preferably 5 to 30 mPa·s. The viscosity of the entire curable composition can be adjusted to the desired viscosity by using compounds with a preferred viscosity as each component so that the viscosity of the entire composition has the desired viscosity.

### Organic Solvent-Free

The ultraviolet light curable composition of the present invention can achieve a suitable viscosity for a coating agent without substantial use of an organic solvent by using each of the aforementioned components, and the ultraviolet light curable composition substantially does not include an organic solvent. In the present specification, the phrase “essentially not containing an organic solvent” means that the amount of organic solvent is less than 0.05 mass % of the total composition, preferably less than or equal to the analytical limit of analytical methods such as gas chromatography or the like. In the present invention, the desired viscosity can be achieved without the use of organic solvents by adjusting the molecular structure and molecular weight of component (A), component (B), and component (C).

The cured product obtained from the curable composition of the present invention can be designed such that desired physical properties of the cured product and the curing rate of the curable composition are obtained and the viscosity of the curable composition is a desired value, depending on the molecular chain lengths of component (A), the position of the cationically polymerizable functional group in each molecule, the molecular structure, and the number of cationically polymerizable functional groups per molecule of component (A). Furthermore, the cured product obtained by curing the curable composition of the present invention is also included in the scope of the present invention. Furthermore, the shape of the cured product obtained from the composition of the present invention is not particularly limited, and it may be a thin film coating layer, may be a sheet-like molded product or the like, may be injected into a specific site in an uncured state and then cured to form a filling material, or may be used as a sealing material for a laminated body, display device, or the like or as an intermediate layer. The cured product obtained from the composition of the present invention is particularly preferably in the form of a thin film coating layer, and is particularly preferably an insulative coating layer.

The curable composition of the present invention is suitably used as a coating agent or potting agent, particularly as an insulative coating agent or potting agent for an electronic device or electrical device.

The cured product obtained by curing the curable composition of the present invention has excellent mechanical properties that can easily be adjusted, and has low dielectric properties. The elastic modulus measured at 25° C. is usually 200 MPa or more, and the relative dielectric constant is usually 3.0 or less. If desired, the cured product obtained by curing the curable composition of the present invention can be designed to have a dielectric constant of 2.7 or less, and the curable composition of the present invention can also be used to form a coating layer having a low relative dielectric constant.

On the other hand, materials with high tensile elongation can be designed using the curable composition of the present invention. When evaluated using a test specimen with a thickness of 0.5 mm at 25° C. and a tensile speed of 50 mm/min, the tensile elongation is usually 10% or more, and by optimizing the curable composition, the tensile elongation of the cured product can be increased to 50% or more. Taking advantage of these characteristics, the cured product is also useful as a layer-forming material for flexible displays.

### Other Additives

Another additive may be added to the composition of the present invention if desired. Examples of additives that can be used include leveling agents, various adhesion promoters, other silane coupling agents, ultraviolet light absorbers, antioxidants, polymerization inhibitors, and fillers (functional fillers such as reinforcing fillers, insulating fillers, and thermally conductive fillers). If necessary, an appropriate additive can be added to the composition of the present invention. Furthermore, a thixotropy imparting agent may also be added to the composition of the present invention, if necessary, particularly when used as a potting agent or sealing material. In particular, the following adhesion-imparting agent may be and is preferably optionally added to the composition of the present invention.

### Adhesion-Imparting Agent

An adhesion promoter can be added to the composition of the present invention to improve adhesion and close-fitting properties to a substrate in contact with the composition. When the curable composition of the present invention is used for applications such as coating agents, sealing materials, and the like that require adhesion or close-fitting properties to a substrate, an adhesion-imparting agent is preferably added to the curable composition of the present invention. An arbitrary known adhesion promoter can be used, so long as the adhesion promoter does not interfere with a curing reaction of the composition of the present invention.

Examples of such adhesion promoters that can be used in the present invention include: organosilanes having a trialkoxysiloxy group (such as a trimethoxysiloxy group or a triethoxysiloxy group) or a trialkoxysilylalkyl group (such as a trimethoxysilylethyl group or triethoxysilylethyl group) and a hydrosilyl group or an alkenyl group (such as a vinyl group or an allyl group), or organosiloxane oligomers having a linear structure, branched structure, or cyclic structure with approximately 4 to 20 silicon atoms; organosilanes having a trialkoxysiloxy group or a trialkoxysilylalkyl group and a methacryloxyalkyl group (such as a 3-methacryloxypropyl group), or organosiloxane oligomers having a linear structure, branched structure, or cyclic structure with approximately 4 to 20 silicon atoms; organosilanes having a trialkoxysiloxy group or a trialkoxysilylalkyl group and an epoxy group-bonded alkyl group (such as a 3-glycidoxypropyl group, a 4-glycidoxybutyl group, a 2-(3,4-epoxycyclohexyl)ethyl group, or a 3-(3,4-epoxycyclohexyl)propyl group), or organosiloxane oligomers having a linear structure, branched structure, or cyclic structure with approximately 4 to 20 silicon atoms; organic compounds having two or more trialkoxysilyl groups (such as trimethylsilyl groups or triethoxysilyl groups); reaction products of aminoalkyltrialkoxysilane and epoxy group-bonded alkyltrialkoxysilane, and epoxy group-containing ethyl polysilicate. Specific examples thereof include vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxycyclohexyl)ethyl trimethoxysilane, 3-methacryloxypropyl trimethoxysilane, 3-methacryloxypropyl triethoxysilane, 1,6-bis(trimethoxysilyl)hexane, 1,6-bis(triethoxysilyl)hexane, 1,3-bis[2-(trimethoxysilyl)ethyl]-1,1,3,3-tetramethyldisiloxane, reaction products of 3-glycidoxypropyl triethoxysilane and 3-aminopropyl triethoxysilane, condensation reaction products of a methylvinyl siloxane oligomer blocked with a silanol group and a 3-glycidoxypropyl trimethoxysilane, condensation reaction products of a methylvinyl siloxane oligomer blocked with a silanol group and a 3-methacryloxypropyl triethoxysilane, and tris(3-trimethoxysilylpropyl)isocyanurate.

The amount of the adhesion promoter to be added to the ultraviolet light curable composition of the present invention is not particularly limited. However, the amount is preferably in a range of 0.01 to 5 mass %, or in a range of 0.01 to 2 mass %, relative to 100 mass % of the curable component due to the curing properties of the curable composition and to prevent discoloration of the cured product.

### Application

The ultraviolet light curable organopolysiloxane composition of the present invention can be cured not only by ultraviolet rays but also by electron beams, which is another aspect of the present invention.

The curable composition of the present invention has low viscosity, and is particularly useful as a material for forming an insulating layer for various articles, particularly electronic and electrical devices. The composition of the present invention can be coated on a substrate or sandwiched between two substrates, at least one of which includes a material that allows ultraviolet rays or electron beams to pass, and the composition can be cured by irradiating ultraviolet rays or electron beams to form an insulating layer. In this case, the composition of the present invention can be patterned when coated on a substrate, and then the composition can be cured. Alternatively, the composition can be coated on a substrate, and cured and uncured portions can be left during curing by ultraviolet rays or electron beam irradiation. Thereafter, an uncured portion can be removed with a solvent to form an insulating layer having a desired pattern. In particular, when the cured layer according to the present invention is an insulating layer, the layer can be designed to have a low dielectric constant of less than 3.0.

The curable composition of the present invention provides favorable transparency of the cured product obtained therefrom, and is particularly suitable as a material for forming an insulating layer for touch panels, displays and other display devices. In this case, an arbitrary desired pattern may be formed as described above, if necessary, on the insulating layer. Therefore, a display device such as touch panel, display, or the like containing an insulating layer obtained by curing the ultraviolet light curable organopolysiloxane composition of the present invention is also an aspect of the present invention.

Furthermore, the curable composition of the present invention can also be used to form an insulating coating layer (insulating film) by curing after coating an article. Therefore, the composition of the present invention can be used as an insulative coating agent. Furthermore, a cured product formed by curing the curable composition of the present invention can be used as an insulative coating layer.

An insulating film formed from the curable composition of the present invention can be used for various applications. In particular, use is possible as a component member of an electronic device or as a material used in a process of manufacturing the electronic device. Electronic devices include semiconductor devices, magnetic recording heads, and other electronic apparatuses. For example, the curable composition of the present invention can be used in an insulating film of a semiconductor device, such as an LSI, system LSI, DRAM, SDRAM, RDRAM, D-RDRAM, or a multi-chip module multilayer circuit board, an interlayer insulating film for a semiconductor, an etch stopper film, a surface protection film, a buffer coat film, a passivation film in LSI, a cover coat for a flexible copper cladding plate, a solder resistant film, and a surface protection film for an optical device.

Furthermore, the ultraviolet light curable composition of the present invention can be used as a coating agent, or as a potting agent, and particularly as an insulative potting agent for electronic devices and electrical devices.

The composition of the present invention can be used as a material for forming a coating layer on a substrate surface, particularly by using an inkjet printing method.

The present invention is further described below on the basis of Examples, but the present invention is not limited to the Examples below.

### EXAMPLES

The ultraviolet light curable composition of the present invention and a cured product thereof of the present invention will be described below in further detail using examples. Furthermore, measurements and evaluations in the Examples and Comparative Examples were conducted as follows.

### Viscosity of Curable Composition

The viscosity (mPa·s) of the composition at 25° C. was measured using a rotary viscometer (E type viscometer VISCONIC EMD produced by TOKIMEC CORPORATION).

### Appearance of Curable Composition and Cured Product Obtained Therefrom

The appearance of the curable composition and cured product obtained therefrom were observed and visually evaluated.

### Preparation of Curable Composition

Each material was placed in a brown plastic container at the amounts listed in Table 1 below and mixed well using a planetary mixer to prepare the curable composition.

### Curing of Curable Composition and Measurement of Outgassing

A coating of the curable composition was prepared by spin coating on a PET film coated with a fluoropolymer release agent. The composition was cured by irradiation with LED light having a wavelength of 405 nm at an energy dose of 2 J/cm² to produce a cured coating having a thickness of 8 μm. The resulting coating was peeled off from the film and 5 to 10 mg was weighed out and placed into a prescribed vial. The cured sample was heated under the following two conditions, and then the gas (unit: ppm) generated upon heating was analyzed and quantified by headspace gas chromatography.
<Condition 1> Hold at 110° C. for 30 minutes
<Condition 2> Hold at 130° C. for 30 minutes

### Curing of Curable Composition and Preparation of Viscoelastic Test Piece

Approximately 0.5 g of curable composition was injected between two glass substrates with a 1 mm thick spacer interposed therebetween. By irradiating LED light having a wavelength of 405 nm at an energy intensity of 2 J/cm² from the outside through one glass substrate, the composition was cured to prepare a rectangular cured product having a length of 50 mm, a width of 10 mm, and a thickness of 1 mm.

### Measurement of Elastic Modulus of Organopolysiloxane Cured Product

A strip-like test piece prepared from the organopolysiloxane cured product was subjected to a viscoelasticity measurement in a temperature range from −40° C. to 160° C. using an MCR-302 dynamic viscoelasticity measuring device manufactured by Anton Paar GmbH under conditions of a frequency of 1 Hz, strain of 0.1%, stress of −0.1 N/mm², and a temperature increase rate 3° C./min, and the value of the storage elastic modulus (units: MPa) at 25° C. was recorded.

### Curing of Curable Composition and Preparation of Sample for Dielectric Constant Measurement

A mold having a thickness of 1 mm having circular holes with an inner diameter of 40 mm was placed on a PET film coated with a fluoropolymer release agent, and approximately 1.3 g of the curable composition was poured into a hole thereof. A PET film similar to that described above was placed over the composition, and a 10 mm thick glass plate was placed thereon. By irradiating an LED light having a wavelength of 405 nm at an energy amount of 2 J/cm² from above, the composition was cured to prepare a disk-shaped organopolysiloxane cured product having a diameter of 40 mm and a thickness of 1 mm.

### Dielectric Constant of Organopolysiloxane Cured Product

A tin foil having a diameter of 33 mm and a thickness of 0.007 mm was pressed onto both surfaces of the prepared organopolysiloxane cured product. In order to improve close-fitting properties between the cured product and the foil, a small amount of silicone oil, if necessary, was used for pressing. The capacitance at room temperature and 100 KHz was measured by an E4990A precision impedance analyzer manufactured by Keysight Technologies to which a parallel plate electrode having a diameter of 30 mm was connected. The dielectric constant was calculated using measured capacitance values, separately measured thicknesses of the cured product, and electrode area values.

### Examples and Comparative Examples

The ultraviolet light curable compositions were prepared at the compositions (parts by mass) shown in Table 1 using each of the following components.
(A1) 1,3-bis[2-(3,4-epoxycyclohexyl)ethyl]-1,1,3,3-tetramethyldisiloxane
(A2) 1,1,1,3,5,5,5-heptamethyl-3-[2-(3,4-epoxycyclohexyl)ethyl]trisiloxane
(B1) Phenol salt of DBU (U-CAT SA1, manufactured by San-Apro Ltd.)
(B2) Ethyl hexanoate of DBU (U-CAT SA102, manufactured by San-Apro Ltd.)
(C) 4-isopropyl-4′-methyldiphenyliodonium tetrakis(pentafluorophenyl)borate
(D) 2-isopropylthioxanthone

TABLE 1

| | | | Compar- | Compar- |
|---|---|---|---|---|
| | Exam- | Exam- | ative | ative |
| Component | ple 1 | ple 2 | Example 1 | Example 2 |
| (A1) | 64.00 | 64.00 | 64.00 | 64.00 |
| (A2) | 34.30 | 34.30 | 34.30 | 34.30 |
| (B1) | 0.20 | — | — | — |
| (B2) | — | 0.20 | — | — |
| (C) | 1.50 | 1.50 | 1.50 | 1.50 |
| (D) | 0.04 | 0.04 | 0.04 | 0.04 |
| Total | 100.0 | 100.0 | 100.0 | 100.0 |
| Appearance of | Trans- | Trans- | Trans- | Trans- |
| curable composition | parent | parent | parent | parent |
| Viscosity of | 19 | 19 | 19 | 19 |
| composition mPa · s | | | | |
| Appearance of | Trans- | Trans- | Trans- | Trans- |
| cured product | parent | parent | parent | parent |
| Outgassing of cured | 210 | — | 280 | — |
| material: Condition 1 ppm | | | | |
| Outgassing of cured | — | 215 | — | 290 |
| material: Condition 2 ppm | | | | |
| Storage modulus of | 560 | 560 | 570 | 570 |
| cured product MPa | | | | |
| Dielectric constant of | 2.6 | 2.6 | 2.6 | 2.6 |
| cured product | | | | |

As can be seen in Table 1, the ultraviolet light curable compositions of the present invention (Examples 1 and 2) have a viscosity at 25° C. that is suitable for application to a substrate as a coating agent, particularly for application by inkjet printing, and the cured product has high transparency. In addition, the amount of outgassing generated from the cured product when held at high temperature (110° C. or 130° C. for 30 minutes in the Examples) is significantly reduced compared to cured products obtained from compositions not containing component (B) (Comparative Examples 1 and 2). On the other hand, the cured products obtained from the ultraviolet light curable compositions (Examples 1 and 2) had sufficiently high storage modulus and sufficiently low dielectric constant compared to the cured products obtained from the curable compositions not containing component (B), and it was confirmed that the addition of component (B) did not substantially adversely affect other properties of the cured product.

### INDUSTRIAL APPLICABILITY

The ultraviolet light curable composition of the present invention is particularly suitable for the applications described above, and particularly as a material for forming an insulating layer for touch panels and displays and other display devices, and particularly flexible displays.

1. An ultraviolet light curable composition, comprising:
(A) one or more organopolysiloxanes or organosilanes having, on average, more than one cationically polymerizable functional group per molecule;
(B) a compound that releases a basic substance when heated at 60 to 200° C.; and
(C) a photoacid generating agent;
wherein the composition is substantially free of organic solvent; and
wherein the viscosity of the entire composition, measured at 25° C. using an E-type viscometer, is 500 mPa·s or less.

2. The ultraviolet light curable composition according to claim 1, wherein component (A) is a linear, branched, or cyclic organopolysiloxane or organosilane expressed by the average compositional formula: 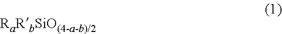
where R is a cationically polymerizable functional group,
R′ represents a group selected from monovalent hydrocarbon groups, hydroxyl groups, and alkoxy groups excluding the cationically polymerizable functional group;
a and b are numbers that satisfy the following conditions: 1≤a+b<4 and 0.01≤a/(a+b)≤0.5, and on average, more than one R is present in each molecule).

3. The ultraviolet light curable composition according to claim 1, wherein component (A) includes: (A1) one or more organopolysiloxane having on average two or more cationically polymerizable functional groups per molecule; and (A2) one or more organosilanes or organopolysiloxanes having one or more cationically polymerizable functional group per molecule.

4. The ultraviolet light curable composition according to claim 3, wherein component (A1) is at least one type of organopolysiloxane having a cationically polymerizable functional group, selected from a group consisting of:
organopolysiloxanes expressed by the following formula (2): 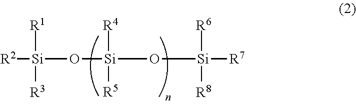
where two or more, on average, of all R¹ to R⁸ groups per molecule are cationically polymerizable functional groups; other R¹ to R⁸ groups independently represent an unsubstituted or fluorine-substituted monovalent hydrocarbon group; and n is a number of 0 or more and 20 or less;
organopolysiloxanes expressed by the average unit formula (3): 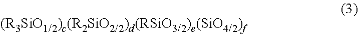
where R independently represents a group selected from cationically polymerizable functional groups and unsubstituted or fluorine-substituted monovalent hydrocarbon groups, at least two of all R's are cationically polymerizable functional groups, (e+f) is a positive number, c is 0 or a positive number, and d is a number within a range of 0 to 10;
cyclic organpolysiloxanes expressed by the following formula (4): 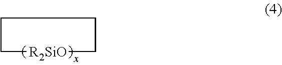
where R independently represents a group selected from cationically polymerizable functional groups and unsubstituted or fluorine-substituted monovalent hydrocarbon groups, x is an integer of 3 to 10, and at least two cationically polymerizable functional groups are present in each molecule); and
mixtures of two or more organopolysiloxanes arbitrarily selected therefrom.

5. The ultraviolet light curable composition according to claim 3, wherein the number of cationically polymerizable functional groups in component (A1) is 2 on average per molecule.

6. The ultraviolet light curable composition according to claim 3, wherein component (A1) is a linear organopolysiloxane having cationically polymerizable functional groups only on both ends of a molecular chain, and having, on average, 2 to 12 silicon atoms.

7. The ultraviolet light curable composition according to claim 3, wherein component (A2) is an organosilicon compound containing in each molecule one cationically polymerizable functional group selected from a group consisting of:
organopolysiloxanes expressed by the following formula (2′): 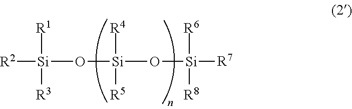
where of all R¹ to R⁸ groups in the formula, only one cationically polymerizable functional group is present in each molecule; the other R¹ to R⁸ are independently an unsubstituted or fluorine-substituted monovalent hydrocarbon group; and n is a number for which the viscosity of a (poly)organosiloxane expressed by formula (2′) is 1 to 20 mPa·s at 25° C., and n may be 0;
cyclic organopolysiloxanes expressed by the following formula (4′): 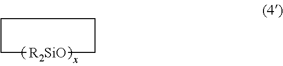
where R is independently a group selected from cationically polymerizable functional groups and unsubstituted or fluorine-substituted monovalent hydrocarbon groups, x is an integer of 3 to 10, and only one cationically polymerizable functional group is provided in each molecule; and
organosilanes expressed by the following formula (5): 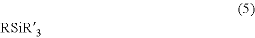
where R is a cationically polymerizable functional group, and R′ is a group selected from monovalent hydrocarbons, hydroxyl groups, and alkoxy groups excluding the cationically polymerizable functional group.

8. The ultraviolet light curable composition according to claim 3, wherein component (A2) is an organopolysiloxane having an average of 3 or more silicon atoms, and one cationically polymerizable functional group in each molecule.

9. The ultraviolet light curable composition according to claim 3, wherein the ultraviolet light curable composition contains component (A1) and component (A2) in a mass ratio (A1/A2) of 10/90 to 90/10.

10. The ultraviolet light curable composition according to claim 1, wherein the cationically polymerizable functional group is an epoxy group-containing group.

11. The ultraviolet light curable composition according to claim 1, wherein the viscosity of the entire composition, as measured at 25° C. using an E-type viscometer, is in a range of 5 to 30 mPa·s.

12. The ultraviolet light curable composition according to claim 1, wherein component (B) is a compound which releases a basic substance when heated at 60 to 120° C.

13. The ultraviolet light curable composition according to claim 1, wherein component (B) is a compound containing a nitrogen-containing cyclic base.

14. An insulating coating agent, comprising the ultraviolet light curable composition according to claim 1.

15. A cured product of the ultraviolet light curable composition according to claim 1.

16. A method of using an insulating coating layer of a cured product of the ultraviolet light curable composition according to claim 1.

17. A display device, comprising a layer of a cured product of the ultraviolet light curable composition according to claim 1.
